(19) United States
(12) Patent Application Publication
(10) Pub. No.: US 2010/0178953 A1
(43) Pub. Date: Jul. 15, 2010

(54) Collaborative Data Sharing

(75) Inventors: Jonathan Ross Blewett, Cambridge (GB); Adam Reid, Hampshire (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/664,843

(22) PCT Filed: Jun. 15, 2007
(86) PCT No.: PCT/GB08/01997

§ 371 Date: Dec. 15, 2009

(30) Foreign Application Priority Data
Jun. 16, 2007 (GB) 0711651.0

(51) Int. Cl. H04M 1/00

(52) U.S. Cl. 455/550.1

(57) ABSTRACT

A mobile communication terminal comprising: a memory for storing user data that is definable when the terminal is in use; a communication transceiver; and a communication controller arranged to identify that a communication link having the terminal as one endpoint and having another communication terminal as the other endpoint is available to the communication transceiver and in response to that determination automatically: requesting data from the other communication terminal; comparing data received in response to that request with corresponding data, if any, contained in the user data; and determining in dependence on that comparison whether to update the user data; and if that determination is positive updating the user data.

This invention relates to sharing data between devices; for example sharing user data between multiple mobile communication terminals.

Devices such as mobile phones, PDAs (personal digital assistants) and portable music players are increasingly being implemented using general purpose processors programmed with appropriate software rather than by means of dedicated processing hardware. As a result, it has become easier to implement a wide range of functions on such devices. Many of these functions involve storing data of various types that can subsequently be viewed or played back by the user. For example, many mobile phones provide facilities for storing information about a user's contacts and appointments; for sending, receiving and storing emails and for storing media such as photographs and music.

The user must arrange for that stored data to be input into the phone somehow. One way to do that is by entering the data directly into the phone, for example by means of the phone's keypad. Another option is to have the data entered into the phone by synchronising the phone with another datastore, which could for example be on the hard disk of a user's personal computer or in the memory of a mail server. When the phone synchronises with the datastore, data can be transferred automatically from the datastore into the phone's memory. This allows the user to use a device other than the phone to enter the data in the first place.

The data might be a message from another person, as in the case of an email. Some integrated email clients such as Microsoft Outlook allow appointment and contact data to be transferred from another user by means of a message similar to an email message. When the message is received it can be automatically integrated into the appropriate one of the recipient's datastores.

People like to share information with their friends and colleagues. Friends might want to let each other know of upcoming events such as a party, or a change to a mutual friend's contact details. Work colleagues might want to keep each other informed of sales leads or upcoming absences from the office. In a work environment, such changes could be propagated by having multiple users synchronise their devices with a common dataset that stores shared information. However, this requires the users to communicate with the server that holds the common dataset, which might be difficult and costly if the users are out of the office. Most personal users do not have access to a shared dataset for synchronisation. They can simply tell each other of data changes, or can send individual messages from one user to another to inform of a specific change: for example by sending an SMS (short message service) message that includes a mutual friend's new phone number. The sending of such messages can be inconvenient, and since they have to be initiated by the users themselves, it may be that updates get missed.

Other ways of sharing content from a mobile device are available or have been proposed. Users of mobile phones can install third-party software to enable weblogs to be updated by deliberately pushing content from the phone to the web. An example of such a weblog publishing application is Cognima's ShoZu application. It allows user-generated content to be automatically uploaded from a phone to a weblog, depending on various user configuration settings. Another example is the Nokia Sensor application for Nokia Series 60 devices. It allows the user of a mobile phone to keep track of other Bluetooth-equipped devices, and to publish small amounts of data to those devices. The Nokia Lifeblog application collects data from various sources on the phone and allows them to be synchronised with a PC as part of the standard synchronisation operation. From there the data can be published to other weblogs. As an alternative to serving that data from an external web server, it has been proposed that the mobile phone itself could act as a web server. These ideas suffer from various disadvantages, most notably that user intervention is required either to publish the data or to access it from another device.

There is a need for an improved way of exchanging information stored on users' personal devices.

According to one aspect of the present invention there is provided a mobile communication terminal comprising: a memory for storing user data that is definable when the terminal is in use; a communication transceiver; and a communication controller arranged to identify that a communication link having the terminal as one endpoint and having another communication terminal as the other endpoint is available to the communication transceiver and in response to that determination automatically: requesting data from the other communication terminal; comparing data received in response to that request with corresponding data, if any, contained in the user data; and determining in dependence on that comparison whether to update the user data; and if that determination is positive updating the user data.

According to a second aspect of the present invention there is provided a method of operating a mobile communication terminal that comprises a memory for storing user data that is definable when the terminal is in use and a communication transceiver, the method comprising: identifying that a communication link having the terminal as one endpoint and having another communication terminal as the other endpoint is available to the communication transceiver and in response to that determination automatically: requesting data from the other communication terminal; comparing data received in response to that request with corresponding data, if any, contained in the user data; and determining in dependence on that comparison whether to update the user data; and if that determination is positive updating the user data.

According to a second aspect of the present invention there is provided software for controlling a mobile communication terminal that comprises a memory for storing user data that is definable when the terminal is in use and a communication transceiver, the software being arranged to: identify that a communication link having the terminal as one endpoint and having another communication terminal as the other endpoint is available to the communication transceiver and in response to that determination automatically: requesting data from the other communication terminal; comparing data received in response to that request with corresponding data, if any, contained in the user data; and determining in dependence on that comparison whether to update the user data; and if that determination is positive updating the user data. Such software may be on a data carrier.

The terminal may be arranged to permit a user to configure which data the communication controller will request from the other communication terminal.

The communication controller may be capable of making at least some of the user data available to the other communication terminal over the communication link. That may be done in the form of a web feed, for example an RSS feed. The terminal may be arranged to permit a user to configure which of the user data can be made available by the communication controller to the other communication terminal. The communication controller may be arranged to only make user data available to the other communication terminal over the communication link if the other communication terminal has authenticated successfully to the communication terminal. The communication terminal may be capable of exchanging security credentials with the other terminal by means of a message using a link other than the said communication link. The communication terminal may be arranged to, subsequent to such an exchange, automatically use those credentials for authentication of the other communication terminal.

The terminal may be a mobile phone. The said message may conveniently be a short message of a mobile phone system, for example an SMS or an MMS message of the GSM system.

The subset of the user data that the communication controller is capable of making available to the other communication terminal over the communication link may include any one or more of calendar data, contacts data and activity logs.

The user data is conveniently data that is definable, either directly or indirectly, by a user of the terminal. The terminal may include at least one environmental sensor for sensing environmental data. The user data may include sensed data that is definable automatically by the terminal in dependence on information sensed by the sensor. The environmental sensor may be a location sensor. The environmental sensor may be capable of sensing the proximity of other devices of a specific type, for example ones having a capability for a particular wireless protocol and/or having a particular identity or class of identity. The sensed data may include information indicative of the proximity of such devices near the terminal at one or more times.

The communication transceiver is capable of acting as the environmental sensor.

The communication transceiver is conveniently a wireless transceiver having an effective range of less than 50 m, more preferably around 10 m.

The terminal may be controlled by an operating system. The communication controller may be a component of the operating system.

The communication controller may be arranged to perform the said determination of whether to update the user data in dependence on input from the user in respect of that potential update.

The communication controller may be arranged to perform the said determination of whether to update the user data in dependence on input from a further terminal that is the subject of that potential update.

The said step of determining may comprise identifying whether the received data comprises a record having one or more primary fields that match the corresponding fields of a record comprised in the user data and one or more secondary fields that do not match the corresponding fields of that record comprised in the user data. The step of updating the data may then comprise altering that record comprised in the user data.

The present invention will now be described by way of example with reference to the accompanying drawing. In the drawing:

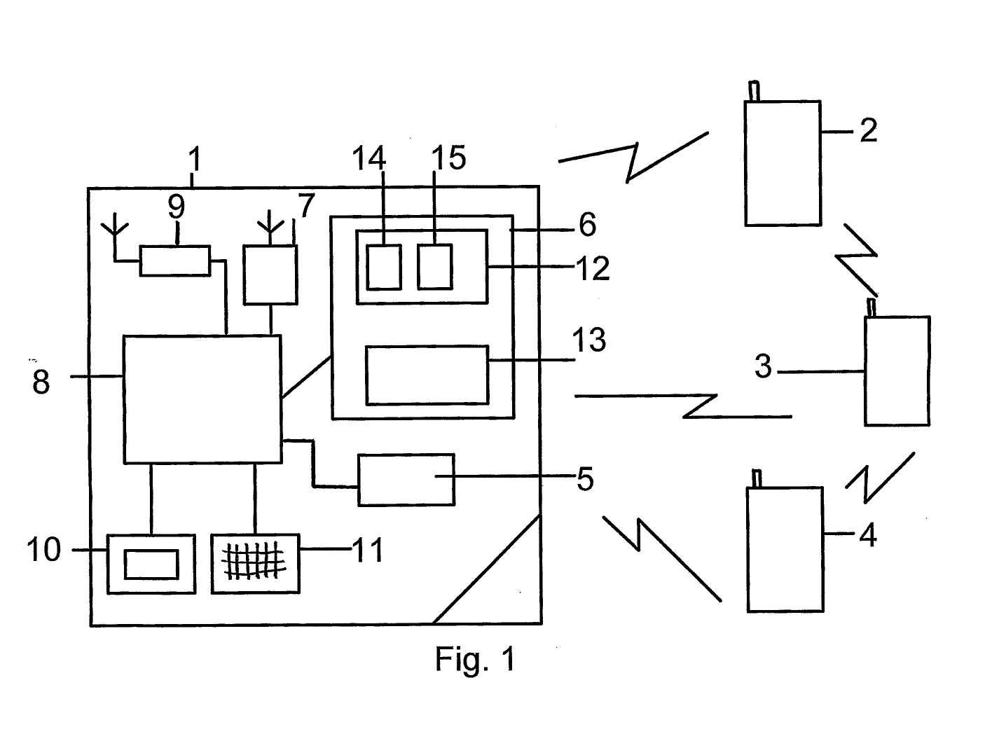

FIG. 1 shows a set of users' personal devices, which are capable of communicating with each other for the exchange of users' information.

FIG. 1 shows a number of mobile phones 1-4 which are capable of communicating with each other using the Bluetooth short-range radio protocol when they are within range of one another. Phone 1 is illustrated in more detail than the others, but all the phones could have componentry as illustrated in phone 1. Phone 1 has a data distribution engine 5, which can access memory 6 of the phone and can communicate with other devices by means of the phone's Bluetooth transceiver 7. In practice the data distribution engine could be implemented in hardware or software or both. The data distribution engine is configured to automatically publish information from the phone's memory 6 to nearby similar devices, and to automatically integrate information received from the similar devices with the data stored in the phone's memory. This allows the phone to automatically distribute information such as appointments or changes of contact details to nearby devices, and to automatically integrate similar received information with the device's own datasets, such as its appointments dataset or its contacts dataset.

The phone 1 of FIG. 1 comprises a central processor 8. The central processor is connected to the memory 6, the Bluetooth transceiver 7, a radio transceiver 9 for communicating with a mobile phone system and a user interface comprising a display 10 and a keypad 11. The memory 6 comprises a non-volatile section 12 which stores program code and user data and a volatile RAM (random access memory) section 13 which is used as a temporary store by processor 8. The non-volatile memory stores the program code that can be executed by the processor. That code includes code 14 defining an operating system and code 15 defining one or more applications.

For clarity the data distribution engine 5 is illustrated as a separate component in FIG. 1. It could be implemented as a hardware component. However, it is most conveniently implemented by means of code stored in the memory 12 and that runs on the processor 8. That code is conveniently integrated into the operating system.

The Bluetooth transceiver 7 is capable of communicating with other Bluetooth transceivers that are within its range. The phone may have other short-range communication devices such as a wireless LAN transceiver, an infra-red transceiver or a UWB (ultrawideband) transceiver, any of which could be used to communicate with nearby devices.

The functions of the data distribution engine will now be described.

The data distribution engine checks periodically to find whether the phone 1 is capable of communicating by Bluetooth with any devices. If it is then the data distribution engine checks whether those devices support the sharing of data with the data distribution engine. It could check this by sending a message of a pre-defined type to such an other device to request that device's capabilities, and analysing the response sent by the device, or there could be a specific Bluetooth profile for sharing data with the data distribution engine.

When it finds a device that supports sharing data with it, the data distribution engine negotiates a data exchange scheme with that device. During this negotiation the two devices exchange information about the datasets that they hold: for example, appointments, contacts and photos. In this way the devices can find information each wants to receive from the other. The negotiation may also involve the exchange of security credentials. Each device may be configured by its user so as to only exchange certain data with certain other devices, so that if the security credentials supplied by another device do not authenticate it as a device with which data sharing is permitted then the device may not share data with it. If the communication medium that is being used relies on the establishment of an authenticated connection then as an alternative to performing that security check during the negotiation phase, it may be performed in dependence on the identity of the other device as authenticated at the connection level. For example, if the identity of the other device has been verified by the Bluetooth transceiver 7 then the data distribution engine can simply check what data it is permitted to share with that device.

Once the negotiation is complete one of the devices (device 1, for instance) sends to the other device (device 2, for instance) some or all of the data that is stored in the datasets from which data was requested by the other device. The data that is sent may be filtered from the totality of the data in each dataset based on a number of parameters. For example:
The device may send only the data that has been changed or added to the dataset since it last shared data with the other device.
The device may filter the data based on settings configured by the user that match the content of certain records in the dataset; for instance only records that have a “share” flag set to TRUE, or only records that contain the word “friend”.
The device may filter the data in dependence on the device with which it is communicating, and its capabilities; for example it may be configured to share certain records in a dataset or certain datasets only with a specific device or devices.

When the data is received the receiving device handles the data according to rules that are pre-stored in its memory. The device may automatically add the received data to its own data store. Alternatively, it may check with the user of the recipient device whether he wants to store the received data. If the received data includes an indication of when it was last changed then the recipient device may check whether one or more key fields of the received data (e.g. a “name” field or a “company” field) correspond to such fields in any records it is already storing and may then update the local record only if the date when the received data was last changed is after the date when the local data was last changed. The received data preferably includes meta-data that indicates the type of the received data: for example whether it is a contact record or an email record. That meta-data allows the recipient device to store the received data in the correct one of its datasets.

One way in which this mechanism could be used is to automatically keep contact information up to date. When one person has updated a contact record on their device, the device of one of their friends could connect to that person's device, receive data from it and recognise that this change has been made in a contact record that corresponds to a record on the friend's device. The friend's device could then ask the friend if he wants to update his copy too, or automatically add it as a new additional phone number, optionally tagged with the name of the person whose device supplied the revised contact information. To recognise such a situation the device can check whether one or more primary fields of a record received from another device match the corresponding fields of an already-stored record when one or more corresponding secondary fields of those records do not match each other. The primary fields are those that identify the record and/or the subject of the record, for instance the name field(s) of a contact record or the title or identity number of an appointment. The secondary fields are the fields that specify attributes of the subject, for example the subject's phone number or the time of an appointment. If the primary fields match and the secondary fields do not then the record may be identified as one that may need to be changed. That change could be made automatically or after confirmation from a user or from another source such as the subject of the record.

The data that is exchanged may be text data that has been entered, for example by a user of the device that transmits the data during the data exchange operation. However, it is advantageous if the data that is exchanged includes data that has been automatically gathered by the transmitting device. The device may have sensors that are capable of sensing environmental data, such as location sensors (e.g. a satellite positioning receiver), velocity and/or acceleration sensors (those parameters could be derived by analysis of satellite positioning data over time), temperature sensors, light sensors and sound sensors. The sensors may be dedicated to environmental data logging or could also be used for other purposes. For example, a light sensor could also provide input for automatically adjusting the brightness of the device's display or as a camera and a sound sensor could be used for detecting voice data for transmission during a phone call. Data from one or more environmental sensors could be logged from time to time by being stored in the memory of the device. That data could then be shared with another device during the data exchange process. This provides a convenient way for a user to share their experiences with other people. The user could, for example choose to share his location over the last 24 hours to allow friends whose devices come within range to automatically see where he has been.

Another example of data that could be sensed is the presence near a first device of a second device with which the first device is able to exchange data. This could be used to facilitate recording interactions with other people or setting up future meetings. When one device detects that it is near one or more other devices with which it can exchange data (by sending and/or receiving in the manner described above) then one or more of the devices could generate a record such as a diary entry in dependence on that proximity event. The presence of devices nearby each other could be detected by them being within range of each other using a short-range protocol such as Bluetooth, or by data that is published by each device indicating the location it detects itself to be in, for example using GPS. If a device detects that its user meets with two or more other users then it could set up a an ad-hoc contacts group to make setting up further such arrangements more convenient.

If the device can sense whether other users' devices are present then during a meeting it could check whether the devices of all the attendees listed in its own calendar for that meeting are present, and if not it could issue an alert.

Another example of data exchange could occur if multiple people are in a meeting and want to arrange another time when they can all meet. They could exchange calendar/appointment information with each other by the mechanism described herein, to enable each of them to each look at their own diary combined with publicly published, or publicly marked busy events of all the people in the group.

Information that relates to operations of the device itself could also be logged and shared. This class of data includes software or hardware events or actions. Examples are phone logs and message logs, web search history, inter-cell transitions, power levels, application usage logs (indicating for instance how often the user played a particular game).

The data could be transmitted from the device in any suitable format. For example, it could be in XML (extensible mark-up language) format or in a standard format used for synchronisation between devices. A preferred option is for it to be provided in the form of one or more web feeds such as RSS (really simple syndication) feeds. The device could conveniently provide one feed for each type of information that it wants to provide. This could be done by the data distribution engine or another component of the device acting as a web server and responding to requests for an RSS feed of a particular address by providing the appropriate data. These feeds could thus be made available to various clients over local or wide area networks. The feeds could be made available to any device that connects to the serving device. More preferably permission to access a feed is granted or denied based on a security mechanism such as the one discussed above, for instance whether the serving device receives secure credentials from the other device.

It is preferred that the devices support a convenient means of exchanging such credentials. An example of a preferred mechanism is by a short message such as the short text message (SMS) or multimedia message of GSM. To do this, one device—most conveniently the device that will serve the data—generates a secure token. That token is sent to the other device by SMS, and the other device then uses that token for authenticating itself to the serving device in future. To make it easy for the user to administer the token, it is preferably sent in a message of a predefined format that will be recognised at the recipient in order that it can be automatically stored. It is preferably automatically stored in conjunction with the identity of the sender, which could be derived from the sending address/number of the message, or the name associated with that address/number in the contacts database of the receiving device. That allows the receiving device to automatically use the appropriate key when authenticating to the sending device.

The use of RSS or other web or generic feed formats allows the data to be played out by devices of different types. If a user's device is generating an RSS feed of certain types of information, such as holiday photos, and there are multiple other people nearby that are interested then the same photos can be streamed to all the viewers in range, which could include PCs and televisions. This saves people crowding around one small screen to view the same content, but real-time reactions are still facilitated.

During the data exchange operation data can be exchanged in both directions in the ways described above.

The present system can allow information to be automatically updated in a receiving device based on data received from another device. A potential consequence of this is that if one person updates a contact and makes a mistake then that mistake could propagate to his friends' devices. To resist this happening, heuristic logic could be employed among a group of devices. Any suitable logic could be used; for example if one device identifies that the data has been automatically changed in its memory and that the user then changes it back then information could be propagated to other devices that causes them to block the initial change from being implemented. Another option is for the device to automatically initiate a message exchange with the subject of the change to see if their details have changed. If they have not then the change could be ignored and/or blocked in respect of other users in a similar way.

A device may recognize from analysing e.g. web logs and locations visited that there is a strong common link in the types of things that its user and another user are interested in. From this the device could recommend an activity that it knows one of the users is interested in to the other like-minded individual. Examples of such activities include visiting websites, receiving RSS feeds, listening to music, making subscriptions to services and watching movies. If the recommendation is for a service in which there is a possible recommendation incentive this could automatically be noted. For example, if person X's device is sharing a feed of ‘I have been playing game “G8574” recently’, and person Y has been playing other games, and so automatically subscribes to the feed, then person Y's device could automatically provide person Y's device with an alert mentioning the game, or a hyperlink that can be accessed to allow person Y to play the game interactively with person X's device.

There is preferably support for marking certain activities or records as private to avoid them being automatically advertised. A user suggestion could be displayed at the first occurrence of a match of a particular interest, for the user to allow or deny the publicising of that activity.

As indicated above, the components of the device that handle the communicating and formatting functions required to support the present data exchange mechanism can be implemented in hardware and/or software. When they are implemented in software the software program may be stored in the form of source code, object code, a code intermediate source and object code such as code in partially compiled form, or in any other form suitable for use in the implementation of processes according to the invention. The computer program may be on or in a carrier. The carrier may be any entity or device capable of carrying the program.

For example, the carrier may comprise a storage medium, such as a ROM (e.g. a CD ROM or semi-conductor ROM), or a magnetic recording medium (e.g. a floppy disk or hard disk). Further, the carrier may be a transmissible carrier such as an electrical or optical signal which may be conveyed by electrical or optical cable or by radio or other means. When the program is embodied in a signal which may be conveyed by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

When the means that implements the data sharing described above is embodied in software, it is preferably (but not necessarily) embodied as part of the operating system of the device. The operating system of the device is the software component that loads automatically when the device is turned on. It controls the access of applications that run on the device to the hardware of the device, including their access to the memory of the device. The operating system is capable of preventing each application from accessing certain areas of the memory that might be reserved to the operating system or to other applications. In contrast, components of the operating system preferably have unrestricted access to any areas of the memory that are accessible by the processor.

The present mechanism of data exchange can be implemented on a wide range of devices. Examples include desktop and laptop computers, personal digital assistants (PDAs), mobile telephones, smartphones, digital cameras and digital music players and converged devices incorporating the functionality of one or more of the classes of device already mentioned, as well as on many other industrial and domestic electronic appliances. The device is preferably portable. The device preferably has a self-contained power source such as a battery or a fuel cell that can power the device when it is operating to exchange data.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1-20. (canceled)

21. A mobile communication terminal comprising:
a memory for storing user data being definable when the mobile communication terminal is in use;
a communication transceiver; and
a communication controller configured to identify that a communication link having the mobile communication terminal as one endpoint and having another communication terminal as the other endpoint is available to the communication transceiver and in response to the determination automatically:
requesting data from the other communication terminal;
comparing data received in response to the request with corresponding data contained in the user data;
determining in dependence on the comparison whether to update the user data; and
updating the user data, if the determination is made to update the user data.

22. A mobile communication terminal as claimed in claim 21, wherein the mobile communication terminal is configured to permit a user to configure data the communication controller requests from the other communication terminal.

23. A mobile communication terminal as claimed in claim 21, wherein the communication controller is configured to make at least some of the user data available to the other communication terminal over the communication link.

24. A mobile communication terminal as claimed in claim 23, wherein the mobile communication terminal is configured to permit the user to configure which of the user data is being made available by the communication controller to the other communication terminal.

25. A mobile communication terminal as claimed in claim 21, wherein the communication controller is configured to receiving data from the other communication terminal over the communication link in form of a web feed.

26. A mobile communication terminal as claimed in claim 21, wherein the communication controller is configured to receive the data from the other communication terminal over the communication link if the mobile communication terminal has authenticated successfully to the other communication terminal.

27. A mobile communication terminal as claimed in claim 26, wherein the mobile communication terminal is configured to exchange security credentials with the other communication terminal and is configured to, subsequent to the exchange, automatically use those credentials for authentication.

28. A mobile communication terminal as claimed in claim 21, wherein the data that the communication controller is configured to receive from the other communication terminal over the communication link includes one or more of calendar data, contacts data, and activity logs.

29. A mobile communication terminal as claimed in claim 21 further comprising at least one environmental sensor for sensing environmental data and the user data includes sensed data that is definable automatically by the mobile communication terminal in dependence on information sensed by the at least one environmental sensor.

30. A mobile communication terminal as claimed in claim 29, wherein the environmental sensor is a location sensor.

31. A mobile communication terminal as claimed in claim 29, wherein the environmental sensor is configured to sense the proximity of other devices of a specific type and the sensed data includes information indicative of the proximity of the devices near the mobile communication terminal at any time.

32. A mobile communication terminal as claimed in claim 29, wherein the communication transceiver is configured to act as the at least one environmental sensor.

33. A mobile communication terminal as claimed in claim 21, wherein the communication transceiver is a wireless transceiver having an effective range of less than 50 meters.

34. A mobile communication terminal as claimed in claim 21, wherein the mobile communication terminal is controlled by an operating system and the communication controller is a component of the operating system.

35. A mobile communication terminal as claimed in claim 21, wherein the communication controller is configured to perform the said determination of whether to update the user data in dependence on input from the user in respect of the potential update.

36. A mobile communication terminal as claimed in claim 21, wherein the communication controller is configured to perform the said determination of whether to update the user data in dependence on input from a further terminal being a subject of the potential update.

37. A method of operating a mobile communication terminal comprising a memory for storing user data being definable when the mobile communication terminal is in use and a communication transceiver, the method comprising:
identifying by a communication controller that a communication link having the mobile communication terminal as one endpoint and having another communication terminal as the other endpoint is available to the communication transceiver and in response to the determination automatically:
requesting data from the other communication terminal;
comparing data received in response to the request with corresponding data contained in the user data;
determining in dependence on the comparison whether to update the user data; and
updating the user data if the determination is made to update the user data.

38. A method for operating the mobile communication terminal as claimed in claim 37, wherein determining comprises identifying whether the received data comprises a record having at least one primary field that matches the corresponding fields of a record in the user data and at least one secondary field that does not match the corresponding fields of the record in the user data, and wherein updating the user data comprises altering the record in the user data.

39. A computer program product for controlling a mobile communication terminal comprising a memory for storing user data, the user data being definable when the mobile communication terminal is in use and a communication transceiver, the computer program product comprising instructions for:
identifying that a communication link having the mobile communication terminal as one endpoint and having another communication terminal as the other endpoint is available to the communication transceiver and in response to the determination automatically:
requesting data from the other communication terminal;
comparing data received in response to the request with corresponding data contained in the user data;
determining in dependence on the comparison whether to update the user data; and
updating the user data if the determination is made to update the user data.
